(19) United States
(12) Patent Application Publication
(10) Pub. No.: US 2026/0078551 A1
(43) Pub. Date: Mar. 19, 2026

(54) PAVING STONE HAVING BUMPERS ON THE SIDES THEREOF, A GROUP OF PAVING STONES ARRANGED TOGETHER, A METHOD FOR MANUFACTURING PAVING STONES FOR GROUP INTALLATION, AND A METHOD FOR INSTALLING A PLURALITY OF PAVING STONES

(71) Applicant: Cold Spring Granite Company, Cold Spring, MN (US)

(72) Inventors: Richard Anderstedt, Clearwater, MN (US); Luke Miller, Cold Spring, MN (US); Jordan Massmann, Cold Spring, MN (US)

(21) Appl. No.: 19/323,826

(22) Filed: Sep. 9, 2025

Related U.S. Application Data
(60) Provisional application No. 63/694,430, filed on Sep. 13, 2024.

(51) Int. Cl. E01C 5/22; B29C 39/10; B29L 31/10

(52) U.S. Cl. CPC E01C 5/22; B29C 39/10; B29L 2031/10; E01C 2201/02

(57) ABSTRACT

A paving stone includes: (a) a paving stone having a top surface, a bottom surface, and at least one side surface extending from the top surface to the bottom surface; and (b) a bumper pattern comprising at least one bumper formed on the at least one side surface of the paving stone by molding a polymeric material onto the at least one side surface of the paving stone. A group of paving stones arranged together includes: (a) a plurality of paving stones, each paving stone having a top surface, a bottom surface, and a plurality of side surfaces extending from the top surface to the bottom surface; (b) a bumper pattern formed on the plurality of side surfaces of each of the plurality of paving stones by molding a polymeric material; and (c) the plurality of paving stones being arranged together so that the bumper pattern is located between adjacent ones of the plurality of paving stones to provide a gap therebetween. Methods of preparing a plurality of paving stones and installing a plurality of paving stones are provided.

### CROSS REFERENCE TO RELATED APPLICATION

This application claims priority to U.S. Provisional Application No. 63/694,430, filed on Sep. 13, 2024, the entire disclosure of which is incorporated herein by reference.

### FIELD OF THE DISCLOSURE

The present disclosure relates to a paving stone having bumpers on the sides thereof, a group of paving stones arranged together, a method for manufacturing paving stones for group installation, and a method for installing a plurality of paving stones. More particularly, the disclosure relates to paving stones having bumpers molded onto the sides of the paving stones and wherein the molded bumpers provide desired spacing between adjacent paving stones, when installed, and to a method of molding bumpers onto the sides of paving stones.

### BACKGROUND

Paving stones are often used to form a hard surface configured for walking or driving over such as, for example, a floor, a courtyard, a patio, a plaza, an atrium, a terrace, a court, an enclosure, a driveway, and a road. Paving stones having flat sides are often applied or placed to form the hard surface using a spacer located therebetween to provide a consistent gap between adjacent paving stones. Such spacers are typically preformed and placed between adjacent paving stones when the paving stones are applied or placed in the location of use. In the case where the paving stones are made from concrete, they can be created with integral spacers extending from the sides of the paving stone and the integral spacers can provide the desired spacing or gap distance between adjacent paving stones. This is beneficial, for example, when applying large numbers of pavers at a time using, for example, a S19 paver laying machine from Optimas. When using such a machine, a large number or group of pavers that are assembled together are pinched, and thereby held in place, and moved and deposited at the location where they will form the hard surface. Thus, the machine can be used to apply a large number of paving stones in a given amount of time and with a minimal number of operators. Even without the use of the machine, a pallet or a large number of the paving stones with integral spacers can be deposited and then applied singly, for example, to the desired location. In either situation, the integral spacers on the concrete paving stones are advantageous to help define the desired gap between adjacent paving stones without the need of adding preformed spacers therebetween.

Paving stones are often referred to as pavers and are generally arranged for forming a hard surface or walking or driving over. Exemplary paving stones include bricks, concrete pavers, tiles, and natural and synthetic stone. Bricks and concrete pavers are often formed individually in, for example, molds and allowed to harden. In contrast, natural and synthetic paving stones are often cut from a larger material. For example, natural stone may be quarried and then cut into smaller paving stones. Even synthetic stones are often formed in a large slab and then cut into smaller paving stones. Exemplary natural materials that are often used to form paving stones include granite, marble, limestone, and sandstone.

Paving stones having flat sides are often placed to form a hard surface with at least one preformed spacer located between adjacent paving stones to provide a desired gap separation. A flat side of a paving stone can be a result of how the paving stone is made. For example, a brick or a concrete paver can be formed having a flat sides, and a natural stone or a synthetic stone can be cut to have flat sides. Attempts have been made to adhere preformed spacers to the flat sides of paving stones, but the preformed spacers have a tendency to fall off as a result of storage and/or transportation. For example, permitting the paving stones to experience seasonal temperature swings during storage may have a tendency to allow the adhered preformed spacers to become less well attached to the sides of the paving stones thereby allowing them to fall off. Transportation may cause vibration or movement (for example, bumping) that results in the spacers becoming less well attached to the sides of the pavers.

While paving stones having integrally formed spacers are advantageous because they can be grouped together and stored over several seasons and transported to a location of use and applied using a group paver laying machine, it is desirable for paving stones having flat sides to be available for use in similar applications. For example, it is desirable for paving stones having flat sides to be grouped together in large numbers and/or on pallets and having spacers molded in place therebetween to provide a desired gap distance, and where the grouped paving stones can be utilized with a machine (for example, the S19 paver layer machine by Optimas) for application of a large number of paving stones at a time to form a hard surface. In addition, it is desirable for the pallets or large groups of paving stones having flat sides and spacers molded thereon to be assembled at one location, permitted to sit outdoors through seasonal changes, and then transported to a location of use without the molded spacers falling off the sides of the paving stones.

### SUMMARY

A paving stone is provided according to the present disclosure. The paving stone includes: (a) a paving stone having a top surface, a bottom surface, and at least one side surface extending from the top surface to the bottom surface; and (b) a bumper pattern comprising at least one bumper formed on the at least one side surface of the paving stone by molding a polymeric material onto the at least one side surface of the paving stone.

A group of paving stones arranged together is provided according to the present disclosure. The group of paving stones includes: (a) a plurality of paving stones, each paving stone having a top surface, a bottom surface, and a plurality of side surfaces extending from the top surface to the bottom surface; (b) a bumper pattern formed on the plurality of side surfaces of each of the plurality of paving stones by molding a polymeric material; and (c) the plurality of paving stones being arranged together so that the bumper pattern is located between adjacent ones of the plurality of paving stones to provide a gap therebetween.

A method of preparing a plurality of paving stones is provided according to the present disclosure. The method includes: (a) molding a polymeric material to at least one side of a plurality of paving stones to form a bumper pattern on each of the at least one side of a plurality of paving stones, wherein each of the plurality of paving stones have a top surface, a bottom surface, and a plurality of side surfaces extending from the top surface to the bottom surface; (b) curing the polymeric material to form the bumper pattern, wherein each bumper pattern comprising at least one bumper that extend at least 1 mm from the side of the paving stone on which the bumper is molded; and (c) assembling the plurality of paving stones together so that adjacent ones of the plurality of paving stones are separated by the bumper pattern.

A method of installing a plurality of paving stones is provided according to the present disclosure. The method includes: (a) grasping a plurality of paving stones and moving the plurality of paving stones to a location where the plurality of paving stones are released for installation, wherein: (i) each of the plurality of paving stones have a top surface, a bottom surface, and a plurality of side surfaces extending from the top surface to the bottom surface; (ii) at least a portion of the plurality of side surfaces of each of the plurality of paving stones having a bumper pattern formed by molding a polymeric material thereon; and (iii) the plurality of paving stones being arranged together so that the bumper pattern is located between adjacent ones of the plurality of paving stones to provide a gap therebetween.

### BRIEF DESCRIPTION OF THE DRAWINGS

Exemplary embodiments of the disclosure are explained in more detail by the description which follows and are represented in the attached drawings, in which:

FIG. 1 is a schematic view showing a robotic arm grasping a paving stone delivered on a conveyor;

FIG. 2 is a schematic view showing the robotic arm and paving stone of FIG. 1 delivering the paving stone to a molding station wherein a bumper pattern is molded onto a first short side of the paving stone utilizing a mold;

FIG. 3 is a schematic view showing the robotic arm and paving stone of FIG. 2 wherein a bumper pattern is molded onto a first long side of the paving stone utilizing a mold;

FIGS. 4A-D are alternative views of an exemplary paving stone having a bumper pattern molded on the four sides thereof according to the present disclosure;

FIG. 5 is a perspective view of an exemplary bumper molded onto a side of a paving stone; and

FIG. 6 is a perspective view of a group of paving stones on a pallet according to the present disclosure.

### DETAILED DESCRIPTION

Paving stones are sometimes referred to as pavers for simplicity and are often placed on the ground in a pattern or design to form a hard surface that can be walked on or driven over. In general, paving stones have a top surface that forms the top or exposed surface that is often the hard surface intended to be walked on or driven over, an opposite bottom surface, and at least one side surface extending from the top surface to the bottom surface. Often, paving stones have a rectangular shape, and sometimes a square shape, having four sides. Paving stones can be provided with alternative shapes. For example, paving stones can have greater than four sides including, for example, five sides, six sides, seven sides, or eight sides, or more. In addition, paving stones may have less than four sides including, for example, three sides (for example, triangular shaped), two sides, or even one side in the case of a circle or oval shaped paving stone.

A plurality of paving stones are typically arranged next to each other and it is often desired that a consistent spacing or gap is provided between adjacent paving stones. Some commercially available concrete paving stones have built-in spacers or integral spacers that are formed as part of the concrete paving stones and that automatically provide the correct or desired spacing between adjacent paving stones when they are arranged next to each other.

Sometimes the integral spacers of adjacent pavers contact each other to provide the gap distance and sometimes the integral spacers of adjacent pavers do not contact each other, and that typically needs to be taken into account when laying pavers.

Other types of paving stones, such as bricks, natural paving stones, and synthetic paving stones, have sides that are flat. Even concrete paving stones can be provided with flat sides. The sides can be flat because either the paving stones are formed that way or the paving stones are cut along the sides thereby providing a flat surface. For example, in the case of paving stones formed from natural stone, the paving stones are typically cut from a larger stone. The cutting results in the sides of the paving stone being flat. It should be appreciated that the reference to “flat” is for distinguishing from paving stones where the sides include integral spacers. It should be appreciated that stone, for example, would typically have a relatively rough surface after a cut, and the reference to “flat” is not intended to indicate that the surface is smooth or lacking any texture. Rather, the reference to “flat” means that the surface does not include a projection thereon, wherein the projection is part of the paving stone material itself, that forms a spacer for consistently separating adjacent paving stones when arranged next to each other. For example, a flat surface can be characterized as lacking a side surface projection thereon greater than 1 mm away from a remainder of the side surface.

In order for paving stones having flat sides to provide a consistent gap between adjacent paving stones, a preformed spacer can be inserted between adjacent paving stones in order to maintain the consistent gap between adjacent paving stones. Application of preformed spacers is typically done by manual application which is time and labor consuming. Furthermore, when using a group paver laying machine such as the S19 paver layer by Optimas, preformed spacers applied to a group of paving stones may fall out from between adjacent pavers at some point during use by the machine thereby resulting in uneven application of the pavers or gaps in the pattern. If the preformed spacers are adhered to the sides of flat pavers at one location, and then the group of pavers are transported to another location, or if the group of pavers are permitted to undergo seasonal temperature changes, there is risk that the preformed spacers may fall out of place thereby causing a problem with providing a consistent gap between adjacent pavers.

According to the present disclosure, the flat sides of paving stones can be modified to include bumpers molded thereon so that when the paving stones are assembled together, they are arranged to provide a desired spacing or gap between adjacent paving stones due to the presence of the molded bumpers. The bumpers described herein are not “preformed” bumpers because they are molded in place on the flat sides of the paving stones. According to the present disclosure, reference to “preformed bumpers” means that the bumpers are formed and then adhered to the paver rather than formed essentially in situ on the paver according to the present disclosure. The bumpers that are formed in place can be referred to as “molded bumpers” indicating that they are molded in place on the sides of the paving stones rather than preformed by, for example, molding and curing to some extent, and then adhering the molded bumpers to the flat sides of the paving stones. Furthermore, by molding the bumpers onto the sides of the paving stones, the bumpers can be aggressively attached to the sides of the paving stones and can remain in place even when a group of paving stones is stored over several seasons, when the group of paving stones is transported to a location of use, and when the group of paving stones is manipulated by a group paving stone applicator machine. Furthermore, the bumpers can be molded in place in the form of a “bumper pattern” which is explained in more detail below. In general, a bumper pattern refers to one or more bumper(s) applied on a side of a paving stone in a consistent manner across a plurality of paving stones to provide a desired gap between paving stones that are adjacent when installed.

The paving stones can be made of any material whether natural or synthetic (for example, artificial stone). Exemplary natural stone materials include, for example, granite, marble, limestone, and sandstone. In addition, the paving stones can be made from concrete or can be provided as brick material. In addition, synthetic materials can be utilized to form paving stones.

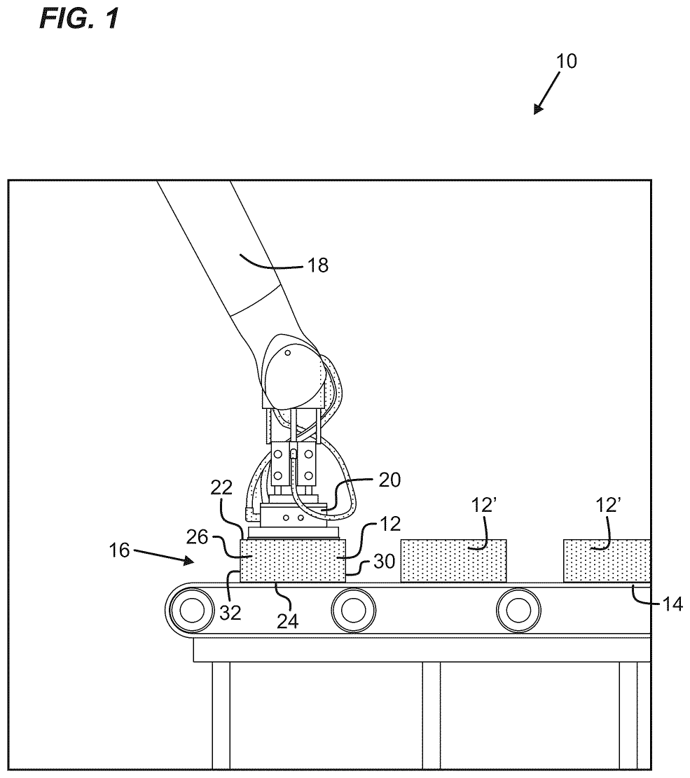

Now referring to FIGS. 1-3, an exemplary method for molding bumpers onto the sides of paving stones is illustrated at reference number 10. According to the exemplary method 10, paving stones 12, 12′, 12″ are delivered via a conveyor 14 to a ready location 16. Prior to delivery on the conveyor, the paving stones are washed with water to clean the top and side surfaces at a wash station, and dried at a drying station or line where fans blow away moisture. It is desirable for the top and sides of the paving stones to be clean so that they can be lifted off the conveyor 14 and bumpers can be molded onto the sides. At the ready location 16, a robotic arm 18 having a suction device 20 attaches to the paving stone 12 on one of the opposite surfaces 22 and 24 of the paving stone 12 (preferably, the clean and dry surface). It is noted that one of the opposite surfaces 22 and 24 is the surface that is exposed when the paving stone is eventually applied at a location of use. The suction device 20 may be used to hold the paving stone 12 on either of the opposite surfaces 22 and 24. The paving stone 12 is a rectangular paving stone having opposite short sides 26 and 28 and opposite long sides 30 and 32. As illustrated, the sides 26, 28, 30, and 32 extend between the opposite surfaces 22 and 24. While the paving stone 12 is illustrated as a rectangular paving stone, it should be appreciated that other shaped paving stones can be utilized by the presently disclosed method including paving stones having fewer than four sides and paving stones having greater than four sides, and even when the paving stone has four sides, the paving stone can be square or another shape having four sides such as rhombus, parallelogram, trapezoid, kite, etc. The particular paving stone 12 illustrated is a 4 inch by 8 inch paving stone.

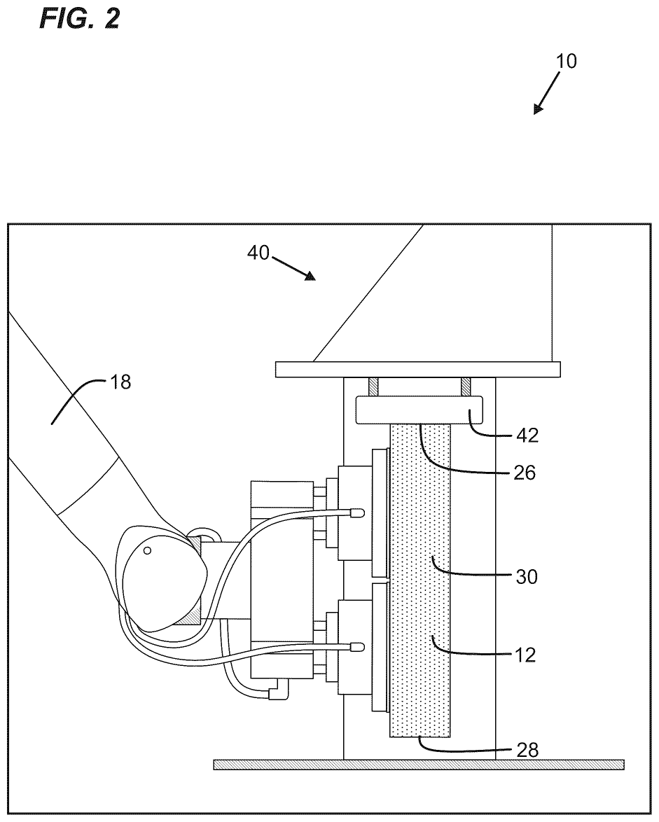

Now referring to FIG. 2, the robotic arm 18 delivers the paving stone 12 to a molding station or location 40 where the short side 26 is applied against the mold 42. Immediately preceding the application of the paving stone 12 against the mold 42, the robotic arm 18 delivers the paving stone 12 to a dispenser where a premeasured amount of adhesive is applied to form each bumper on the short side 26 of the paving stone 12. The adhesive is dispensed hot to help with flow. The adhesive can be referred to as a polymeric material. The robotic arm 18 then moves the paving stone 12 to an adjacent molding station 40 that includes a mold 42 for forming the bumpers on the short side 26 of the paving stone 12. The mold 42 is provided as a chiller plate that flash freezes the outside of the dispensed adhesive thereby forming a cured shell of the exterior of each bumper. It is the mold 42 that forms the dispensed adhesive into the desired shape and flash freezes the outside thereof, and the flash freezing permits the adhesive to be demolded quickly from the mold 42. The polymeric material is preferably a hot melt polyurethane adhesive resin although other types of polymeric material can be applied that provide a suitable bumper extending from the side 26. Other exemplary adhesive that may be used include, for example, epoxy adhesives and polyester adhesives. A preferred hot melt polyurethane adhesive is one that includes 4,4-methylenediphenyl diisocyanate. The polymeric material should be one that provides a sufficiently aggressive adhesion to the side of the paving stone so that it resists falling off with ambient temperature changes (for example, seasonal temperature changes) and transportation induced vibration. In addition, the application of the polymeric material can be accelerated by applying the polymeric material utilizing heat, and then cooling the polymeric material sufficiently before the robotic arm 18 removes the paving stone 12 from the molding station 40 in order to assist with demolding. After the bumpers have been applied to the sides of the paving stone 12, the paving stone 12 can be stacked on a pallet where continued curing of the adhesive can take place, preferably within about 48 hours to fully cure.

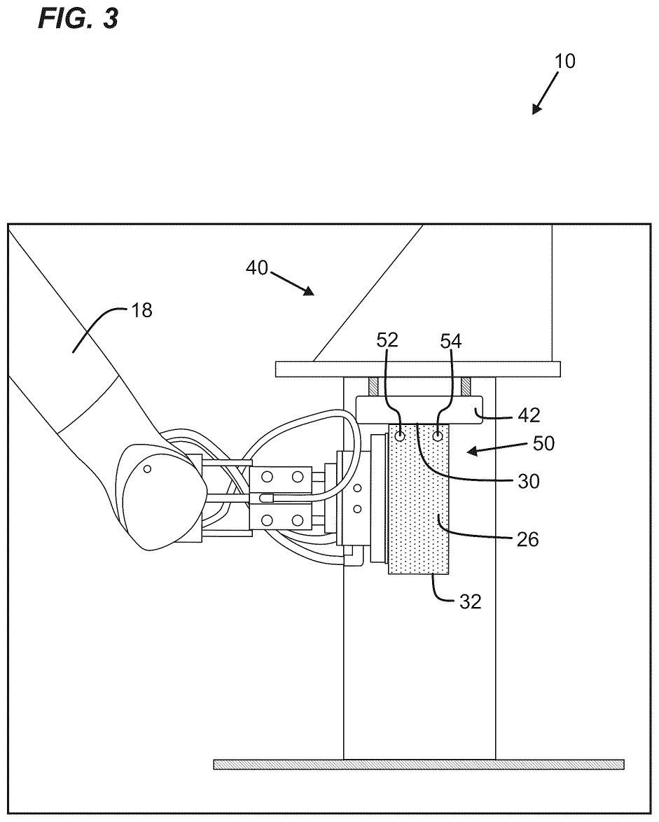

As illustrated in FIG. 3, while at the molding station 40, the robotic arm 18 can rotate the paving stone 12 and adhesive can similarly be dispensed on the long side 30 and then the long side 30 can be applied against the mold 42 so that the dispensed adhesive formed into the desired shape and chilled by the chiller plate so that the polymeric material is molded to the long side 30. Similarly, and the molding process can be repeated for applying the polymeric material to the short side 28 and the long side 32. The robotic arm 18 can then place the resulting paving stone 12 having bumpers molded on the sides thereof in a group of similar paving stones where the bumpers provide the desired gap separation between adjacent paving stones. The robotic arm 18 then repeats the process by picking up the next paving stone 12′ delivered to the ready location 16 by the conveyor 14, and then repeats the process for paving stone 12″, etc.

As illustrated in FIG. 3, a bumper pattern or arrangement 50 is illustrated by individual bumpers 52 and 54. The bumper pattern or arrangement 50 can be provided on each side of the paving stone, or on some sides but not on others, and the bumper pattern or arrangements may be the same or different on the various sides. Because the purpose of the bumpers is to provide a desired and consistent gap or separation between adjacent paving stones, it is preferable that the bumper arrangement provides that bumpers from different paving stones do not contact each other when assembled together or otherwise interfere with each other. One way to do this is to index or locate the bumpers at the same non-central location on each side of the paving stone. For example, by placing the bumper pattern or arrangement 50 a set distance from the leading edge of each side, as long as the location is not central to each side, then the bumpers on adjacent paving stones will not interfere with each other.

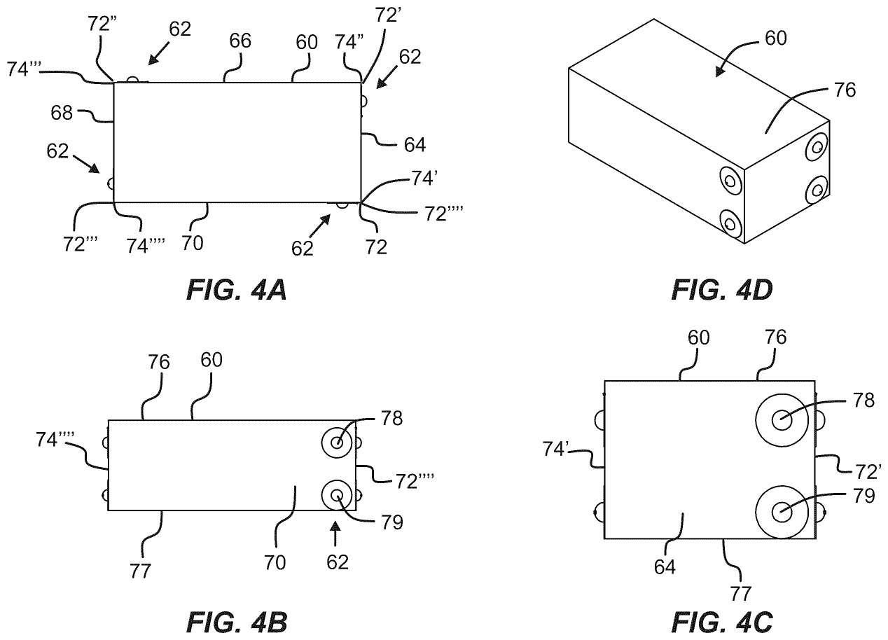

By way of example, FIGS. 4A-D show top, long side, short side, and perspective views of an exemplary paving stone 60 having a bumper pattern 62 on each side 64, 66, 68, and 70 of the paving stone 60. Each side is illustrated having a leading edge 72 and a trailing edge 74. For example, first side 64 has a leading edge 72′ and a trailing edge 74′, second side 66 has a leading edge 72″ and a trailing edge 74″, third side 68 has a leading edge 72″′ and a trailing edge 74′″, and fourth side 70 has a leading edge 72″″ and a trailing edge 74″″. In each case, the bumper pattern 62 can be located a set distance from the leading edge 72 of each side toward the trailing edge 74 of the same side, but not in the middle so that the bumpers of adjacent paving stones do not interfere with each other, although alternatives are possible. In this way, there is no need to specifically orient the paving stones when placing them in a group arranged next to each other wherein the spacing of adjacent paving stones is the height of the bumpers. It should be appreciated that the reference to “middle” regarding the placement of the bumper patterns is a reference to an interfering location where bumpers on adjacent paving stone interfere or contact each other because the bumpers have a perimeter size and the reference to arrangement or pattern includes the area that the bumper(s) on a particular side occupy. The paving stone 60 is also illustrated with top side 76 and bottom side 77, and the bumper pattern 62 is shown with bumpers 78 and 79 although alternative numbers of bumpers can be provided.

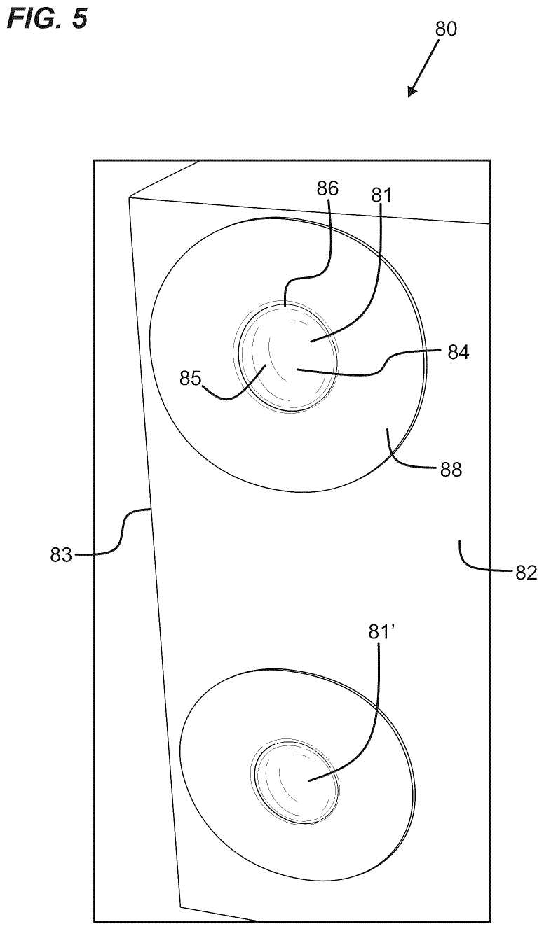

Now referring to FIG. 5, a perspective view of a bumper pattern or arrangement 80 that has been molded onto a paving stone side 82 is illustrated. The bumper pattern 80 is provided as two bumpers 81 and 81′ applied and indexed a set distance from the leading edge 83. Both bumpers 81 and 81′ are identically shaped. The bumper 81 includes an extension portion 85 that is shown as a spherically shaped portion 84 but the portion could have a different shape such as conical or cylindrical or pyramidal shape or another shape. The extension portion 85 permits the bumper 81 to define the gap distance between adjacent paving stones. The spherical shape is advantageous to help with demolding from the mold. Furthermore, a different shape of the bumper can be provided and/or the bumper can be provided with a draft angle to help with demolding. At the base 86 of the extension portion 85 is provided a flange portion 88 of the bumper 81 which is optional and, when present, provides greater surface area for adhesion of the bumper 81 to the paving stone side 82. For the illustrated bumper 81, the extension portion 85 and the flange portion 88 are integral and are formed or shaped by molding the adhesive dispensed onto the paving stone side 82 during the molding step. It is noted that flange portion 88 is advantageous for creating greater surface area to adhere to the paving stone side 82 and thereby keeping the extension portion 85 in position.

It should be appreciated that it is the height of the bumper 81 that provides the gap distance between adjacent paving stones. In view of this, the shape of the bumpers can be any shape that provides and supports the designed bumper height, helps adhere the molded bumpers onto the sides of the paving stones, and that permits successful demolding. One skilled in the art would understand that the gap separation between adjacent stones may be influenced by the stone size. For example, larger stones may accommodate larger gap distances, and smaller stones may accommodate smaller gap distances. By way of example, smaller paving stone may be able to accommodate gap distances or bumper heights of greater than 1 mm. Larger paving stones may accommodate gap distances or bumper heights of less than about 20 mm. Accordingly, the bumper heights may be about 1 mm to about 20 mm, about 5 mm to about 15 mm, or about 7 mm to about 11 mm. The diameter of the base 86 and the diameter of the flange portion 88 can be selected to provide sufficient adhesion to the paving stone side 82 and support for the height of the bumper 81.

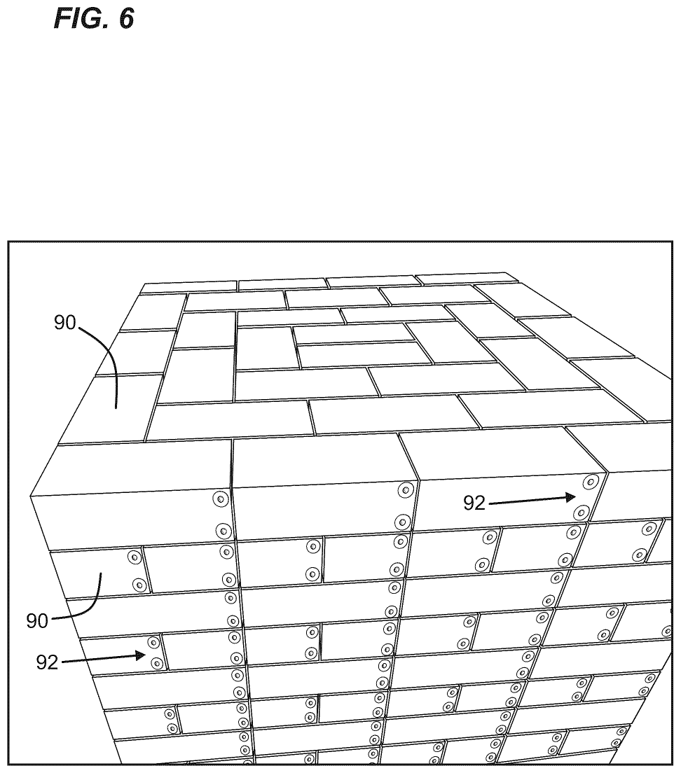

Now referring to FIG. 6, a plurality of paving stones 90 are shown arranged on a pallet. The plurality of paving stones 90 can be referred to as a group of paving stones 90, and each paving stone 90 includes a bumper pattern or arrangement 92 on each side thereof. The bumper pattern or arrangement 92 provides the desired gap separation between adjacent paving stones 90. The paving stones 90 stacked on a pallet, can be allowed to remain in place after forming the bumper patterns 92 until they are cured which can be about 48 hours. Anytime after curing, the pallet or group of paving stone 90 can be moved to a location where they will be used. For example, a machine can pinch a layer of the paving stone 90 from the stacked pallet, and then lay them in place when forming, for example, a hard surface for walking or driving over. Then, another layer can be applied in a similar manner, and repeated until the pallet is emptied or the project is completed.

As discussed previously, paving stones or pavers described herein can be arranged for forming a hard surface for walking or driving over. Such structures can be referred to as horizontal applications even though they may not be absolutely horizontal and may have some slant to provide drainage. It should be understood that the paving stones disclosed herein can be used in stairway applications and in vertical applications. Exemplary vertical applications include buildings where the paving stones can be provided as, for example, cladding or exterior. In such applications, the bumpers provide the desired gap distances between adjacent paving stones.

Exemplary paving stone laying machines that can be utilized using the group of paving stones according to this disclosure include the previously mentioned S19 paver layer machine by Optimas, the Tiger Stone laying machine from Vanku, and the UniLyft machine from Unilock, by way of example. It should be appreciated that other machines that utilize groups of assembled paving stones can similarly be utilized.

While the present disclosure includes an explanation of the formation of bumpers or spacers on a paver surface by, for example, molding, it should be appreciated that a variation of this method can be practiced where an adhesive is applied to or deposited on a paver surface and a preformed structure is applied to or deposited on the previously applied or deposited adhesive. Alternatively, the adhesive can be applied to or deposited on a preformed structure which is then applied to the paver surface so that the adhesive bonds to the paver surface. A potential downside of applying the adhesive to the preformed structure is that the surface area of the adhesive on the paver surface may be limited to the surface area of the preformed structure that receives the adhesive. In the previously described method where the spacer is formed essentially in situ on the paver surface, the surface area of contact between the adhesive and the paver surface can be greater than the surface area of the portion of the deposited material that forms the space separation between adjacent pavers. This increase is surface area of contact can help the spacer to be attached to the paver rather than fall off during storage and/or transport and/or manipulation of the paver. In addition, it should be appreciated that these alternative methods can be practiced with automation where, for example, a robotic arm applies the adhesive to either or both of the surface of the paver or the surface of the preformed spacer, and, in a separate step, the preformed spacer can be applied to the surface of the paver so that the preformed spacer becomes adhered to the paver.

One can appreciate that the invention, a preferred embodiment of which is described herein, includes various alternative embodiments which can be made without departing from the spirit and scope of the invention.

What is claimed is:

1. A paving stone comprising:
(a) a paving stone having a top surface, a bottom surface, and at least one side surface extending from the top surface to the bottom surface; and
(b) a bumper pattern comprising at least one bumper formed on the at least one side surface of the paving stone by molding a polymeric material onto the at least one side surface of the paving stone.

2. A paving stone according to claim 1, wherein:
(a) the paving stone comprising a natural stone material, a synthetic stone material, a brick material, or a concrete material.

3. A paving stone according to claim 1, wherein:
(a) the paving stone comprising a natural stone material comprising at least one of granite, marble, limestone, or sandstone.

4. A paving stone according to claim 1, wherein:
(a) the bumper pattern comprises at least two bumpers molded on the at least one side of the paving stone.

5. A paving stone according to claim 1, wherein:
(a) the paving stone having a rectangular shape with four of the side surfaces, and each side surface comprising the bumper pattern thereon.

6. A paving stone according to claim 5, wherein:
(a) each of the four side surfaces comprise a bumper pattern extending away from a remainder of the paving stone a distance of greater than 1 mm.

7. A paving stone according to claim 1, wherein:
(a) the at least one bumper extends away from the at least one side of the paving stone at least about 1 mm.

8. A paving stone according to claim 1, wherein:
(a) the at least one bumper extends away from the at least one side of the paving stone about 1 mm to about 20 mm.

9. A paving stone according to claim 1, wherein:
(a) the bumper has a spherical shaped portion and a base having a flange portion.

10. A group of paving stones arranged together comprising:
(a) a plurality of paving stones, each paving stone having a top surface, a bottom surface, and a plurality of side surfaces extending from the top surface to the bottom surface;
(b) a bumper pattern formed on the plurality of side surfaces of each of the plurality of paving stones by molding a polymeric material; and
(c) the plurality of paving stones being arranged together so that the bumper pattern is located between adjacent ones of the plurality of paving stones to provide a gap therebetween.

11. A group of paving stones according to claim 10, wherein:
(a) the bumper pattern comprises at least two bumpers.

12. A group of paving stones according to claim 10, wherein:
(a) the plurality of paving stone each have a rectangular shape with four of the side surfaces, and each side surface comprising the bumper pattern thereon.

13. A group of paving stone according to claim 11, wherein:
(a) each of the bumpers extends away from the side surface of the paving stone about 1 mm to about 20 mm.

14. A method of preparing a plurality of paving stones comprising:
(a) molding a polymeric material to at least one side of a plurality of paving stones to form a bumper pattern on each of the at least one side of a plurality of paving stones, wherein each of the plurality of paving stones have a top surface, a bottom surface, and a plurality of side surfaces extending from the top surface to the bottom surface;
(b) curing the polymeric material to form the bumper pattern, wherein each bumper pattern comprising at least one bumper that extend at least 1 mm from the side of the paving stone on which the bumper is molded; and
(c) assembling the plurality of paving stones together so that adjacent ones of the plurality of paving stones are separated by the bumper pattern.

15. A method of installing a plurality of paving stones comprising:
(a) grasping a plurality of paving stones and moving the plurality of paving stones to a location where the plurality of paving stones are released for installation, wherein:
(i) each of the plurality of paving stones have a top surface, a bottom surface, and a plurality of side surfaces extending from the top surface to the bottom surface;
(ii) at least a portion of the plurality of side surfaces of each of the plurality of paving stones having a bumper pattern formed by molding a polymeric material thereon; and
(iii) the plurality of paving stones being arranged together so that the bumper pattern is located between adjacent ones of the plurality of paving stones to provide a gap therebetween.

16. A method according to claim 15, wherein:
(a) the bumper pattern comprises at least two bumpers.

17. A method according to claim 15, wherein:
(a) the plurality of paving stones each have a rectangular shape with four of the side surfaces, and each side surface comprising the bumper pattern thereon.

18. A method according to claim 16, wherein:
(a) each of the bumpers extends away from the side of the paving stone about 1 mm to about 20 mm.
